(19) United States
(12) Patent Application Publication
(10) Pub. No.: US 2011/0239447 A1
(43) Pub. Date: Oct. 6, 2011

(54) Recessed fitting installation tool

(76) Inventor: Jeffrey Z. Hansel, Hillsborough, FL (US)

(21) Appl. No.: 12/798,460

(22) Filed: Apr. 6, 2010

(51) Int. Cl. B23P 19/00

(52) U.S. Cl. 29/700

(57) ABSTRACT

The “recessed installation tool” is for remote installation of a fire sprinkler head adaptor, or other device while it is positioned in a recessed or obstructed area that does not allow standard installation methods. This invention is a device for installing sprinkler heads from the type of overhead sprinkler systems commonly found in residential or commercial buildings. The device (or tool) would accommodate the “CPVC CUT BACK KIT” and the specific use of this tool is for obstructed or recessed fire sprinkler heads or adapters with minimum access holes or cuts. It being unique as it is a “code compliant” way to cut back a fire sprinkler head in or above hard ceilings such as drywall, stucco, or plaster without opening up the ceiling to perform the task. This tool is the only code compliant way to reinstall the “head adapter” without damaging the sprinkler head with the CPVC® cement, glue or bonding agent. This installation tool keeps the waterway open as the cement, glue or bonding agent dries. This tool also installs the slip by thread adapter for hose bibs or other fittings of standard ½″, ¾″ or 1″ size that need to be adjusted that are concealed above or behind block, stucco or drywall.

The Head adapter is the CPVC or PVC fitting that adapts from the slip and glue method of CPVC and PVC pipe to the threads on a sprinkler head or other fitting and because it has a penetrating rod that protrudes into the fitting as it is being glued it will keep the waterway open as the cement dries which will never obstruct the waterway/water flow.

This tool may include, but not limited to, use in installation of fire sprinkler heads from overhead sprinkler systems in commercial and all types of buildings during routine installation, renovation, and repair work.

### BACKGROUND

1. Field of Invention

This invention relates to plumbing and fire protection tools, specifically a tool to provide a code compliant means or to a device for installing/removing a CPVC® fire sprinkler head fitting or adaptor, hose bib adaptors, or any other slip or glue by thread adaptors when it is recessed above or behind a wall, ceiling, soffet, or obstruction that does not allow room to install the fitting by standard methods. This tool may include, but not limited to, use in installation of fire sprinkler heads from overhead sprinkler systems or other systems with threaded fittings in commercial buildings. Condominiums, Apartments, Adult Living Facilities or any other building using PVC® or CPVC® during initial routine installation, remodel and/or renovation.

2. Description of Prior Art

Sprinkler heads in the overhead sprinkler systems in commercial buildings require compliance with codes, or laws for all installation repairs and/or remodels. Problems are encountered in the installation of sprinkler heads or other PVC® and CPVC® fittings when the cement or glue enters into the threaded portion, waterway, or threaded object during installation and/or maintenance or repair. This tool is required because these fittings are recessed and/or obstructed which would involve larger access cuts or holes to the drywall, stucco, plaster, wood or other covering to gain complete access to the sprinkler head adaptor or other fitting requiring gluing or cementing and cause additional time and construction costs for code compliant installation of CPVC® fire sprinkler head fittings and adaptors or other slip by thread adapters that must be cemented or glued into place above or behind drywall, stucco, concrete, wood, or any other surface.

A thorough investigation of existing patents has been performed and found nothing that works anything like this tool for installation of a recessed/obstructed access to a sprinkler head adapter, PVC® fitting, CPVC® fitting or other slip, glue, cement or bonded agent by thread fittings that are recessed/obstructed above or behind drywall, stucco, concrete, wood or any other surface ceiling or soffit.

### SUMMARY OF INVENTION

### Objects and Advantages

It is the primary object of this invention to provide a tool to assist efficient code compliant means of installation of CPVC® fire sprinkler head fitting, adaptors, or other fittings when recessed above or behind a wall, ceiling, soffet, or obstruction that does not allow room to install the fitting by standard methods. This tool keeps the waterway open and free of glue, cement or bonding agent during the gluing and/or cementing process. It is also an object of this invention to provide a quick and timely way to adjust a recessed fire sprinkler head, hose bib, or other device that would not be level or properly trimmed, and at time of final inspection and most likely would fail inspection by contractor and/or not be accepted by the owner.
As described herein, properly manufactured and used to assist installation of recessed fire sprinkler heads, adaptors, PVC® fitting, CPVC® fitting or other slip, bonding agent, glue, or cement fittings found in residential or commercial buildings, the present invention would be easy-to-use, reduce access cuts to expose area of sprinkler system during installation, readjustments, and/or removal of CPVC® fire sprinkler heads or adaptors that normally would not be able to be installed by standard methods. This tool would be an intricate part of the “CPVC CUT BACK KIT” to install the heads more efficiently and timely so you will not incur additional time and construction costs. The kit includes two tools that are not included in this patent. The first tool is the inside out PVC® pipe cutter.
Instructions to Recut a Recessed Fitting Using this tool
Step 1. Select the proper depth the pipe must be cut back.
Step 2. Set the depth gauge on the inside out PVC® pipe cutter and using a drill cut back the pipe.
Step 3. Using the recessed pipe reamer; ream the cut pipe to manufacturer's specifications.
Step 4. Using the recessed fitting installation tool install the fitting with the proper amount of glue, bonding agent, or cement. Their recessed fitting installation tool will keep the glue or cement out of the waterway, sprinkler head orifice, other fitting, or threads.

This tool is unique and it is available in sizes fitting all standard sizes of pipe for any fire sprinkler or standard fitting with its tapered head shape and national pipe thread standard to be used on all heads.

### BRIEF DESCRIPTION OF DRAWINGS

FIG. 1. Bottom side view of the invention.

FIG. 2. Top side view of the invention.

FIG. 3. Bottom view of the invention.

FIG. 4. Top view of the invention.

FIG. 5. Side view of the invention.

### DETAILED DESCRIPTION OF PREFERRED EMBODIMENTS

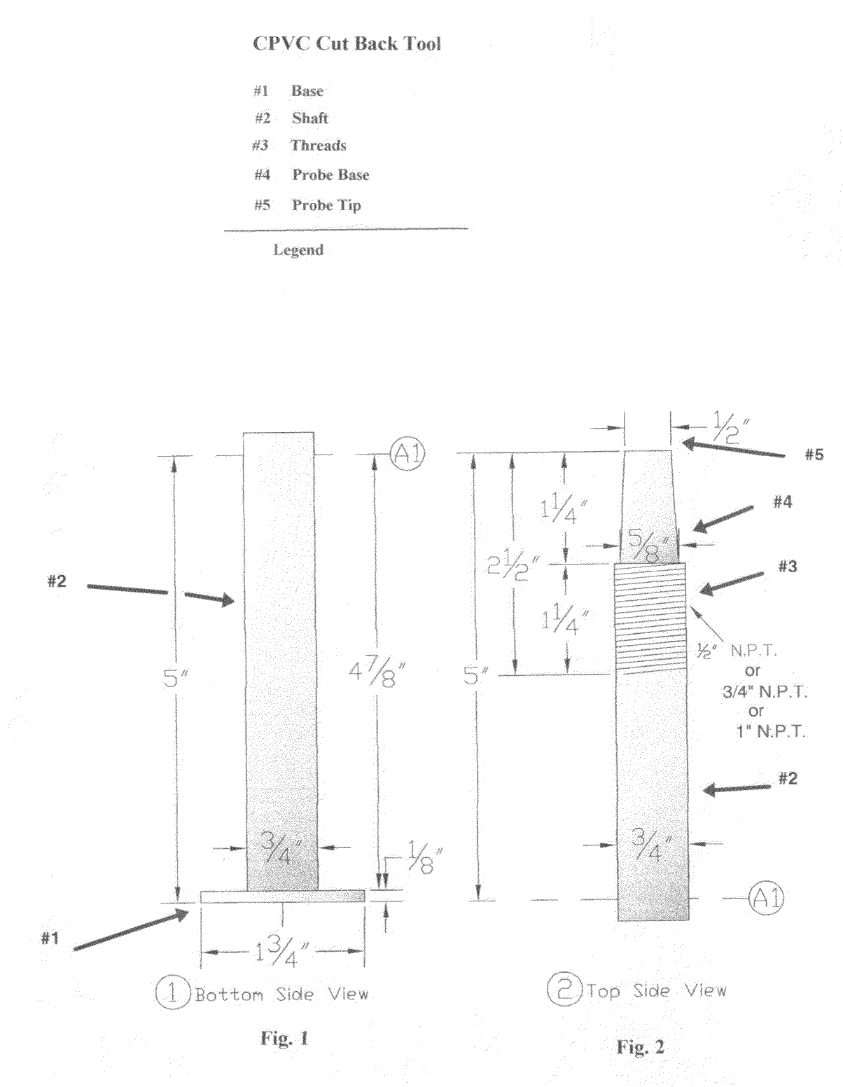

FIG. 1. Shows a preferred embodiment of recessed fitting installation tool invention having a 1¾″ diameter×⅛″ mild steel base/stand and the function of a mild steel handle and/or hand grip during usage. FIG. 1 also shows the base connected to the ¾″ diameter size steel rod shaft.

FIG. 2. Shows the ¾″ shaft extended to the ½″ National Pipe Thread that is 1¼″ in length. Attached to a ⅝″ diameter mild steel shaft that tapers to a ½″ diameter to fit into opening of reducer/coupling.

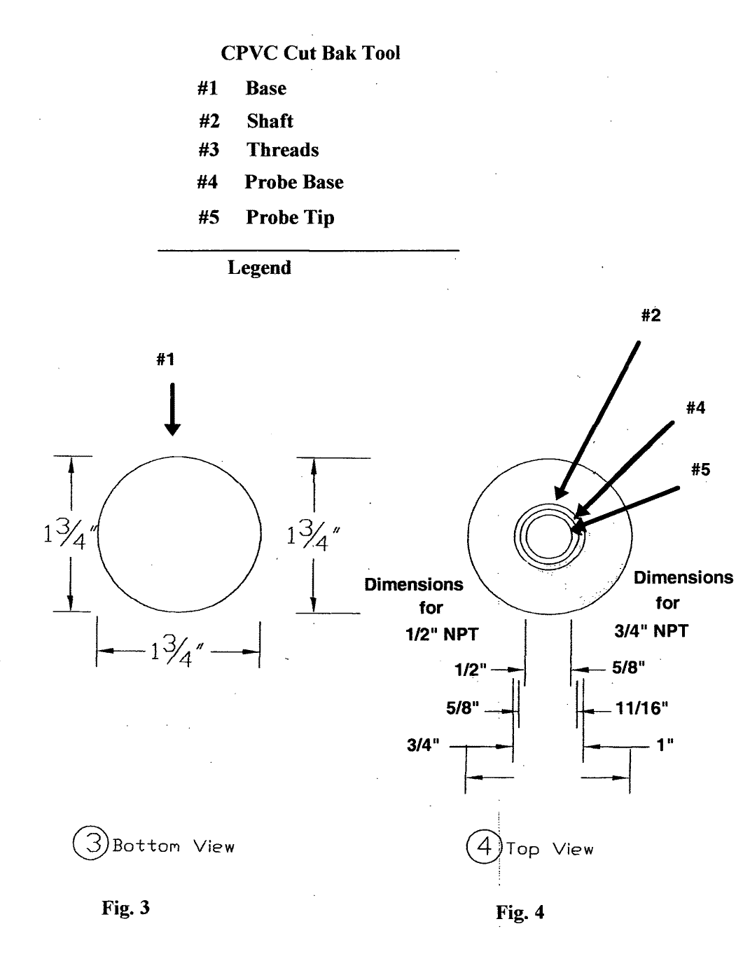

FIG. 3. Shows the bottom view of recessed fitting tool invention with a 1¾″ diameter mild steel base used as a stand and/or hand grip.

FIG. 4. Shows the top view of recessed fitting tool invention with graduated/tapered end connected to the shaft that is attached to the base. Sizes on the left side are for the ½″ NPT tool and sizes on the bottom are for the ¾″ NPT tool.

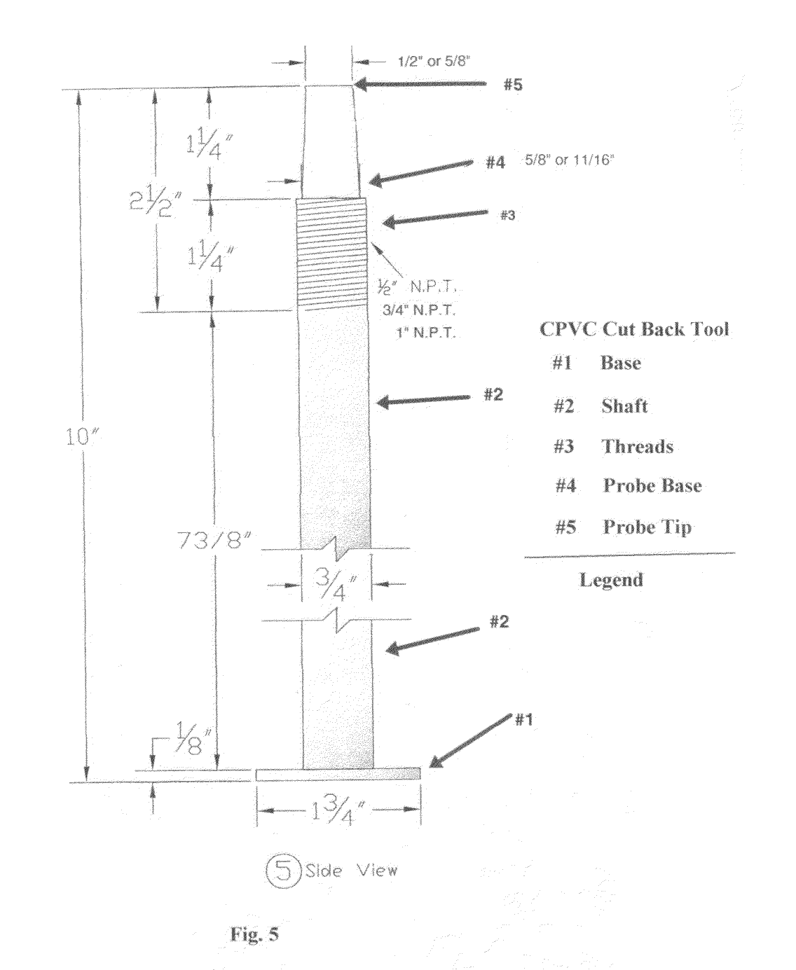

FIG. 5. Shows a preferred embodiment of the recessed fitting tool invention that (1) shows the tapered end that will fit into the opening or that will assist as a handle and gives you a 7⅜″ grip shaft during usage.

### CPVC Cut Back Tool

#1 Base
#2 Shaft
#3 Threads
#4 Probe Base
#5 Probe Tip

What is claimed is:

1. A device for installing fire sprinkler heads from the type of overhead sprinkler system commonly used in commercial buildings that may be recessed or obstructed not allowing room for standard installation methods. This tool would be included in the “CPVC CUT BACK KIT” and specific use of this tool is for obstructed or recessed fire sprinkler heads or adapters, hose bibs or other devices with minimum access cuts.

2. At this time in the fire sprinkler industry there is no “code compliant” way to cut back a fire sprinkler head or other devices in or above hard ceilings such as drywall, stucco, or plaster without opening up the ceiling to perform the task. This creates the cost of repairing the ceiling after the fire sprinkler repair or installation is complete. This problem is not limited to the fire sprinkler industry alone. There are many other instances where this tool is needed such as hose bib fittings on residential homes. If this fitting is required to be adjusted after the drywall or block and stucco is complete there is no way to adjust it without damaging the stucco, block or drywall without this tool.

3. This tool is the only code compliant way to reinstall the “head adapter” without damaging the sprinkler head with the CPVC® cement. This installation tool keeps the waterway open as the cement dries. This tool also installs the slip by thread adapter for hose bibs or other fittings that need to be adjusted that are concealed above or behind block, stucco or drywall.
The Head adapter is the CPVC or PVC fitting that adapts from the slip and glue method of CPVC and PVC pipe to the threads on a sprinkler head or other fitting.

4. This tool is unique because it has a penetrating rod that protrudes into the fitting as it is being glued, cemented or bonded to keep the waterway open as the cement dries.
